(19) United States
(12) Patent Application Publication
(10) Pub. No.: US 2026/0119540 A1
(43) Pub. Date: Apr. 30, 2026

(54) SYSTEM AND METHOD FOR LANGUAGE MODEL ARCHITECTURE WITH DATASET COMPARISONS AT SCALE

(71) Applicant: ROYAL BANK OF CANADA, Toronto (CA)

(72) Inventors: Truman YUEN, Toronto (CA); Graham Alexander WATT, Toronto (CA); Yuri LAWRYSHYN, Toronto (CA)

(21) Appl. No.: 19/170,884

(22) Filed: Apr. 4, 2025

Related U.S. Application Data
(60) Provisional application No. 63/714,705, filed on Oct. 31, 2024.

(51) Int. Cl. G06F 16/3329; G06F 16/334; G06F 40/284

(52) U.S. Cl. CPC G06F 16/3329; G06F 16/334; G06F 40/284

(57) ABSTRACT

A computer-implemented natural language processing method can include storing a criteria embedding generated from a criteria document containing natural language or otherwise unstructured text in a vector database; for each individual document in the throughput of electronic documents: generating, with a first language model, a text summary of the individual document; conducting, using retrieval augmented generation, a semantic search to identify relevant passages from the vector database based on the text summary of the individual document; generating, with a second language model, retrieval-augmented text by performing semantic textual similarity with the identified passages and the text summary of the individual document; and generating, with a third language model, a set of assessment outputs based on the text summary of the individual document and the retrieval-augmented text.

### CROSS-REFERENCE TO RELATED APPLICATIONS

This application claims all benefit of, including priority to, U.S. Provisional Patent Application No. 63/714,705, filed Feb. Oct. 31, 2024, and entitled SYSTEM AND METHOD FOR LANGUAGE MODEL ARCHITECTURE WITH DATASET COMPARISONS AT SCALE, the entirety of which is hereby incorporated by reference.

### FIELD

Embodiments of the present disclosure relate generally to the field of natural language processing, and some embodiments particularly relate to systems, methods and devices for large scale natural language processing with token constraints.

### INTRODUCTION

Generative Large Language Models enable efficient analytics across knowledge domains, rivalling human experts in information comparison. However, the application of LLMs for information comparison faces scalability challenges due to difficulties in maintaining information across large contexts under model token constraints.

### SUMMARY

Some text comparison solutions are limited in applicability due to their dependency on domain-specific training data, computational requirements and data scalability. In some embodiments, aspects of the example systems described herein can automate or otherwise enable information comparison at scale. In some embodiments, the system can be described as an Abstractive Summarization & Criteria-driven Comparison Endpoint (ASC ²End) system which combines abstractive summarization and retrieval augmented generation (RAG), creating a pre-retrieval RAG process to overcome token limitations and retain relevant information during model inference. In some embodiments, example methods can include data-handling strategies with advanced prompting techniques to establish a paradigm in pre-retrieval RAG for information comparison tasks which may eliminate the need for extensive domain-specific training. In some embodiments, ASC ²End incorporates Semantic Text Similarity comparisons to generate evidence-supported analyses. In some example scenarios, performance of the system showed significant overall accuracy (94%), with improved efficiency and comparable runtimes versus a baseline. In some embodiments, aspects of ASC ²End provide a system and/or tool that enables accurate, automated information comparison at scale for applications across knowledge domains such as financial services.

In accordance with one aspect, there is provided a method for a computer-implemented natural language processing architecture. The method includes generating a criteria embedding from a criteria document containing natural language or otherwise unstructured text, and storing the criteria embedding in a vector database; receiving or accessing an electronic document corpus comprising a throughput of electronic documents; for each individual document in the throughput of electronic documents: generating, with a first language model, a text summary of the individual document; conducting, using retrieval augmented generation, a semantic search to identify relevant passages from the vector database based on the text summary of the individual document; generating, with a second language model, retrieval-augmented text by performing semantic textual similarity with the identified passages and the text summary of the individual document; and generating, with a third language model, a set of assessment outputs based on the text summary of the individual document and the retrieval-augmented text.

In accordance with another aspect, there is provided a method for a computer-implemented natural language processing architecture. The method includes: generating a criteria embedding from a criteria document containing natural language or otherwise unstructured text, and storing the criteria embedding in a vector database; receiving or accessing an electronic document corpus comprising a throughput of electronic documents; for each individual document in the throughput of electronic documents: generating a reduced-token abstractive summary data set for the individual document with a first language model; conducting, using retrieval augmented generation, a semantic search to identify relevant criteria data from the criteria embedding vector database based on the reduced-token abstractive summary data set; generating, with a second language model, retrieval-augmented text by performing semantic textual similarity with the identified criteria data and the reduced-token abstractive summary data set of the individual document; and generating, with a third language model, a set of assessment outputs based on the reduced-token abstractive summary data set of the individual document and the retrieval-augmented text.

In accordance with another aspect, there is provided a system for a computer-implemented natural language processing architecture. The system includes: a processor; and a non-transitory memory storing one or more sets of instructions that when executed by the processor, configures the system for: generating a criteria embedding from a criteria document containing natural language or otherwise unstructured text, and storing the criteria embedding in a vector database; receiving or accessing an electronic document corpus comprising a throughput of electronic documents; for each individual document in the throughput of electronic documents: generating a reduced-token abstractive summary data set for the individual document with a first language model; conducting, using retrieval augmented generation, a semantic search to identify relevant criteria data from the criteria embedding vector database based on the reduced-token abstractive summary data set; generating, with a second language model, retrieval-augmented text by performing semantic textual similarity with the identified criteria data and the reduced-token abstractive summary data set of the individual document; and generating, with a third language model, a set of assessment outputs based on the reduced-token abstractive summary data set of the individual document and the retrieval-augmented text.

In accordance with another aspect, there is provided a non-transitory computer-readable medium or media having stored thereon machine interpretable instructions which, when executed by a processing system, configures the processing system for generating a criteria embedding from a criteria document containing natural language or otherwise unstructured text, and storing the criteria embedding in a vector database; receiving or accessing an electronic document corpus comprising a throughput of electronic documents; for each individual document in the throughput of electronic documents: generating a reduced-token abstractive summary data set for the individual document with a first language model; conducting, using retrieval augmented generation, a semantic search to identify relevant criteria data from the criteria embedding vector database based on the reduced-token abstractive summary data set; generating, with a second language model, retrieval-augmented text by performing semantic textual similarity with the identified criteria data and the reduced-token abstractive summary data set of the individual document; and generating, with a third language model, a set of assessment outputs based on the reduced-token abstractive summary data set of the individual document and the retrieval-augmented text.

### BRIEF DESCRIPTION OF THE FIGURES

FIG. 1 is a schematic diagram showing aspects of a computer system and data flows for an example natural language processing architecture.

FIG. 2 shows a series of bar graphs showing performance metrics for different example embodiments.

FIG. 3 shows another series of bar graphs showing performance metrics for different example embodiments.

FIG. 4 is a schematic diagram showing aspects of an example computing device.

FIG. 5 is a flowchart showing aspects of an example method.

These drawings depict exemplary embodiments for illustrative purposes, and variations, alternative configurations, alternative components and modifications may be made to these exemplary embodiments.

### DETAILED DESCRIPTION

The applications of generative Large Language Models (LLMs) across knowledge domains, including financial services, are expanding due to their ability to perform multiple tasks such as abstractive summarization, simple QA (Question-Answering), multiple choice QA, financial sentiment analysis, Retrieval Augmented Generation (RAG), among others. These open-domain tasks have recently been popularized in specific applications, enabling time efficiencies in the analytics required for informed decision-making.

In some embodiments, generative LLMs described herein refer to autoregressive models. Generative LLMs can be used in executing abstractive summarization, and in some embodiments can be executed through semantic splitting instead of a traditional token length split, which may present better-contextualized summaries. In some situations, training LLMs on labelled datasets may increase information retention during inference.

Fine-tuning generative LLMs can increase a model's overall performance in a specific domain. However, prompting strategies may be used to leverage the performance capabilities of naive generative LLMs without relying on large, domain-specific training data sets, with some minor trade-offs in performance. In some situations, zero-shot and few-shot prompting techniques can be leveraged to direct answer structures and elicit human-like reasoning for response generation. A recent study demonstrated the ability of naive generative LLMs to perform Named Entity Recognition (NER) and Relation Extraction (RE) for tasks that reflect human-like reasoning. Chain-of-thought reasoning can also be elicited in zero-shot prompting strategies using phrases such as “let's think step-by-step” to reflect human-like reasoning. Additionally, altering the available input context and the order in which information is presented in a prompt can affect the final output response structure.

In some embodiments, semantic textual similarity (STS) is a driving factor in effective information comparison. STS can be measured through many different techniques that can help in text classification and topic extraction without the limitations of lexical similarity. In some embodiments, semantic similarity may be executed with generative LLMs by implementing prompting strategies. In some embodiments, using retrieval augmented generation (RAG) may provide additional context based on a user query such that an LLM can generate an in-domain output response. In some embodiments, RAG can apply STS to find the top-k passages most similar to the user query and enhances the information in its output response. In some embodiments, modular components of RAG pipelines can be applied for example as pre and/or post-retrieval data processing to better augment the output of RAG.

In some situations, decision-making and data analysis may substantially benefit from text analyses made available by STS through generative LLMs. For example, medical frameworks have been used to screen abstracts of scientific papers to be used for review papers. In some examples, generative LLMs can be used to compare scientific abstracts with user-defined criteria and sort the abstracts based on the eligibility generated by the model. In some example, generative LLMs are used to perform information comparisons against user-defined criteria such that the model can make binary categorical decisions. Similarly, in financial domain examples, a corporate sustainability report was compared to a sustainability guideline document in the chatReport. chatReport supported different QA tasks regarding the information in the sustainability report, powered by RAG. This framework handles individual reports and generates responses for single-use applications.

However, applying LLMs for information comparison is currently non-trivial at scale due to token limitations imposed on many LLMs. Minimizing information loss and prompting under token limits can be a challenge that must be addressed to expand system functionality. Models with longer token limits are prone to losing information from the input context, for example, due to limitations in relevant information retrieval, from the middle of long input contexts. For example, it has been shown that naive, untrained models with no input context performed better on the same QA task when compared to the models provided with a lengthy input context. Given these challenges, new strategies must be explored to enhance effective and efficient information retrieval while overcoming token limitations.

In some situations, aspects of the example embodiments described herein may provide an LLM framework that improves text comparison accuracy and scalability by addressing token limitations and contextual information loss while minimizing computational resources. Some example embodiments are referenced as ASC ²End (Abstractive Summary & Criteria-driven Comparison Endpoint), which comprises a system which may, in some situations, enable accurate, automated information comparison at scale for applications across financial services and other knowledge domains. In some embodiments, through abstractive summarization, RAG and prompt engineering, ASC ²End introduces a pre-retrieval RAG workflow that may provide efficient, large-scale information comparison across knowledge domains without extensive domain-specific knowledge. Other pre-retrieval RAG approaches can be limited by the complexity and volume of text provided to its process and abstraction research exhibits dependencies in extensive model finetuning. In some situations, ASC ²End may robustly handle complex RAG tasks and may eliminates the need for model fine-tuning.

In one example application, embodiments of the present disclosure may be applied to the challenge of identification and evaluation of financial transactions against complex, user-defined sustainable finance criteria. As described herein, performance of some example embodiments have been evaluated using ROUGE and survey responses.

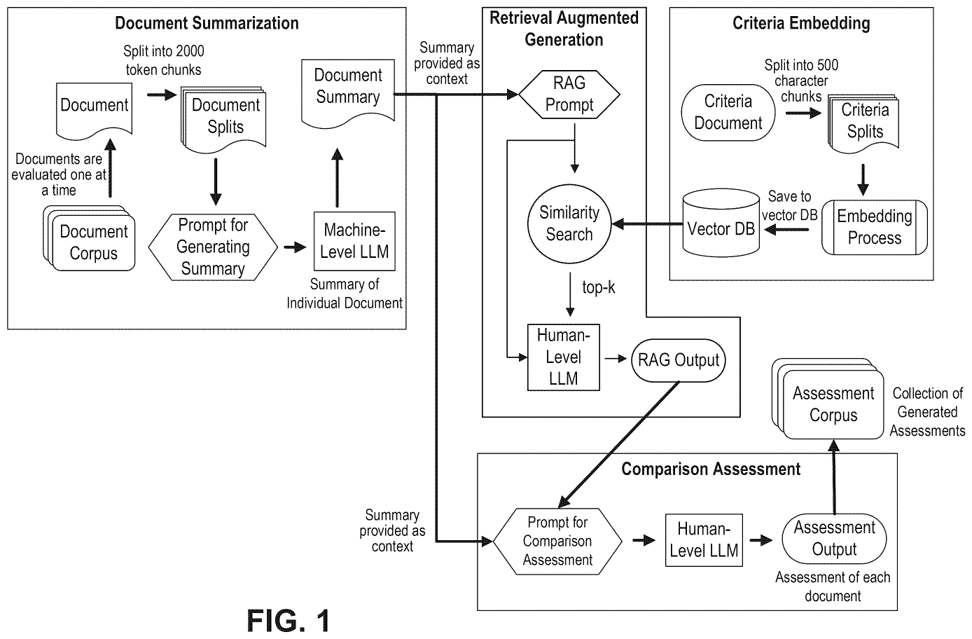

FIG. 1 is flowchart illustrated aspects of an example computer-implemented natural language processing architecture and a corresponding example data flow.

In some embodiments, the system provides insights by comparing a given text corpus against a set of user-defined criteria. This comparison evaluates the relevance of each document in the corpus to a user-defined topic. In some embodiments, the ASC ²End system is built using abstractive summarization, RAG, binary QA tasks, and reasoning tasks which have, in some situations, been effective when deployed with generative LLMs. In some embodiments, zero-shot prompting is implemented to enable more flexibility across applications as it may remove the need for model finetuning. In some embodiments, the system presents a new approach to the pre-retrieval step of the RAG process through the application of abstractive summarization to relieve token usage while retaining semantic context for extended input contexts.

In some embodiments, the ASC ²End system can be implemented using one or more processors, memories, and/or storage devices. The processors can be configured to execute one or more software or hardware instructions. In some embodiments, the software and/or hardware components of the system configured to execute one or more of the functions and/or aspects of the example methods described herein can be logically, conceptually or structurally divided into modules or components.

In the discussion of the example embodiments below, the system is described in four logical components; however, as would be understood by the skilled person, in other embodiments, the system may not be divided in this manner or may be configured as a single system or component, or any number of systems and/or components.

As illustrated in FIG. 1, an example system can be visualized as having 4 components that process the user-specified information and generate the comparison assessment. The first two components, Document Summarization (DS) and Criteria Embedding (CE), perform the input processing of the given text corpus and user-defined criteria respectively. The third component, Retrieval Augmented Generation (RAG), facilitates the similarity search to retrieve and output the relevant information for the next component. The last component, Comparison Assessment (CA), performs the comparison tasks with the preprocessed data as input. The DS component iteratively performs abstractive summarization on individual documents from the given text corpus to generate a summary for each document. The DS component functions as a pre-retrieval step for the RAG component to distill relevant context efficiently. The CE component vectorizes and splits the user-defined criteria document, storing the segments in a vector database. The RAG component uses the vector database to drive a similarity search between the summary from the DS component, combined with the RAG prompt and the user-defined criteria to return the top-k passages. These passages are fed in with the RAG prompt to a human-level LLM to provide an augmented output of these passages to the CA. In the last step, the CA component uses the information provided by the RAG component and the summary from the DS component to generate an output comparison assessment.

In some embodiments, the Document Summarization (DS) and Criteria Embedding (CE) components are configured to preprocess the inputted information (e.g. as provider or identified as inputs by the user). In some embodiments, inputs are highlighted at the beginning of each component (document corpus in DS and criteria document in CE). The document summary is supplied to both the Retrieval Augmented Generation (RAG) prompt and the Comparison Assessment (CA) module. The vector database is used to drive the similarity search in the RAG module. The RAG prompt is combined with the results of the similarity search, where the information is relayed to a human-level LLM to enhance the retrieved passages. The CA module uses the information preprocessed from the DS and CE modules to perform the comparison assessment task using the same human-level LLM as the RAG process. Highlighted in the final step are the generated assessments for each document.

As described herein or otherwise, in some embodiments, the system can be configured to perform large-scale comparisons which are facilitated through the system's data preprocessing steps on a given text corpus and set of user-defined criteria. In one example application used to validate the performance of the system, a financial news dataset was used as the candidate text corpus and selected a relevant criteria document as the user-defined criteria.

In some embodiments, different LLMs are used for different aspects of the system/method. In some embodiments, the LLM are selected based on whether the function can benefit from machine or human-level reasoning. The performance of abstractive summarization done by machine-level LLMs of some example embodiments was evaluated using the ROUGE (Recall-Oriented Understudy for Gisting Evaluation) metric. The performance of the comparison assessment done by human-level LLMs was evaluated using survey participants to optimize the output coherence, quality of the response, and accuracy of the retrieved information of some example embodiments.

In some embodiments, the system is configured by dividing processing tasks into two tiers of complexity: a first tier which involves less complex machine reasoning or which can otherwise be effectively handled by smaller, faster and/or less complex natural language processing process(es); and a second tier which involves more complex machine reasoning or which otherwise is handler by larger and/or more complex natural language processing process(es). In the present application, the term first tier and “machine-level” may be used interchangeably; and the term second tier and “human-level” may be used interchangeably.

In some situations and in some embodiments, the multitier architecture may provide for smaller memory requirements, less training, and/or less processing time required to execute the tasks.

In some embodiments, the system's components can be selected based on whether a model was suitable for machine-level or human-level tasks based on current approaches and the overall task complexity. In some situations, larger parameter models are more likely to generate human-like responses, which reflected human-like reasoning when providing solutions to tasks. In some embodiments, parameter sizing can be used to configure these two types of reasoning tasks.

In some embodiments, machine-level reasoning tasks are defined as those that LLMs perform successfully as demonstrated by previous studies. The performance of these tasks can be evaluated using NLP precision metrics, such as ROUGE and BLEU scoring without the need for human intervention or validation. Examples include NER and abstractive summarization tasks that require simple relation extraction abilities from the LLM.

In some situations, human-level reasoning tasks require several different solving strategies when provided to a model and result in a response that reflects chain-of-thought reasoning when arriving at a final answer. Human-level reasoning tasks may also require the LLM to understand the information semantically, such that the desired output is acquired. Additionally, the performance of these tasks can involve human validation testing and feedback to ensure final output coherence. Examples of human-level reasoning include performing STS and text comparison tasks and generating responses from criteria-driven prompts.

While various LLMs may be used, in some embodiments, the LLMs for the machine and human-level reasoning tasks was selected based on the comparative performance of several generative LLMs. Answers and scores provided by generative LLMs are prone to hallucinations and imperfect logic during model inference. In some embodiments, this was addressed by assigning the appropriate generative LLMs for different reasoning tasks. Additionally, tests showed a strong correlation of model size to its performance on test bench tasks.

In some embodiments, Llama-2 7B, 13B, Mistral 7B, and GPT 3.5 may be used to execute machine-level reasoning task based on their cost-efficient performance for their parameter size. In some embodiments, the threshold for determining the reasoning power of the models was chosen based on the trend notice between the training parameter size and expected model performance. In some embodiments, Llama-2 13B can be used as the sole 13B model to evaluate the effects of larger parameters on the summarization task. In some embodiments, GPT 3.5 can be used based on its significant performance difference in reasoning tasks compared to GPT 4, as machine-level reasoning tasks do not require as much reasoning power.

In some embodiments, human-level reasoning models can be implemented using Llama-2 70B and GPT 4. These are currently, at the time of writing, the most competitive LLMs to be used for complex-level reasoning while fitting within current experimental constraints. However, in other embodiments, other suitable models may be used. Larger parameter models can generate human-like text, reflecting that these models may be better suited to elicit human-like reasoning.

ROUGE (Recall-Oriented Understudy for Gisting Evaluation) was used to measure the quality of the abstractive summaries produced by the generative LLMs. ROUGE calculates the overlap of unigrams, bigrams, and longest common subsequences between the generated summaries and the reference texts, offering a comprehensive measure of summary accuracy. In a study, ROUGE-1 (unigrams), ROUGE-2 (bigrams), and ROUGE-L (longest common subsequences) were focussed on to capture different aspects of summary quality. ROUGE-1 and ROUGE-2 analyze the summary's keyword retention and overall text accuracy. ROUGE-L provides insight into a summary's precision and context retention based on the length of exact text subsequences retained from the original text. These metrics provided an understanding how summaries were retaining information systematically.

These measures are used in NLP to assess text accuracy and align with recent large-scale summarization studies, which also use ROUGE for evaluation. The performance of embodiments of the present application, as evaluated with ROUGE, showed competitive results against these state-of-the-art systems, confirming the validity of the system in real-world applications.

Evaluation of the human-level LLMs' performance in the comparison assessment was a complex task that required the validation of output readability and correct process reasoning. Therefore, human feedback was collected through the creation of a survey. A dataset was created by randomly selecting and masking 20 model output pairs that correspond to the same document summary, with one of each pair generated by either the GPT-4 or Llama-2-70B model to allow for comparison of performance between the models. As a result, the survey comprised of ten GPT-4 response outputs and ten Llama-2-70B response outputs. The same survey was distributed to all participants for consistency. Randomly sampling the model output dataset may introduce bias in the results. However, since the models were being evaluated comparatively, the empirical scores had a lower impact on the overall analysis.

The survey used a 5-point scoring system by asking participants to answer 5 questions per document entry, as shown in the table below. Each question was scored either a 0 (no) or 1 (yes). The first three tasks evaluated the ability to retrieve information from the input context and the last two tasks evaluated the reasoning abilities of the selected LLM. This scoring method was chosen to lower answer scoring ambiguity. Each participant was provided with an explanation of their task along with the user-defined criteria document. Participant data was completely masked for confidentiality and participants had no formal domain knowledge in finance or sustainability.

Roles of Participants Stated
Transaction Type Identification
Transaction Amount ($) Identification
Comparison to sustainability criteria is justified
Do you agree with the confidence score
& explanation?

In some embodiments, the system is configured to perform preprocessing on both an input text corpus and a set of user-defined criteria. In one example application, the text corpus can include financial data sourced from a news database. In some embodiments, this data can include raw, unstructured data. In some embodiments, document summarization was performed with generative LLMs to process the raw financial data. The user-defined criteria document is uploaded to a vector database for use by the system to conduct similarity searches.

In one example application of the system, the data search scope was to analyze a financial institution's publicly available transaction records (i.e., the text corpus) and compare them with the institution's sustainable finance guidelines (i.e., user-defined criteria). For example, the text corpus for the analysis were sustainable finance reports from the financial institution for 2020-2022. In some embodiments, any number of years or other timeframes can be used as the system is configured to enable frequent data analyses without limitations.

In some embodiments, the text corpus includes articles from various open-source news outlets and information posted on the SEC EDGAR database. In some embodiments, the text corpus can be obtained by a web scraping process. In some embodiments, the text corpus can be continually expanded as new electronic documents are scraped, identified, uploaded or otherwise added to the text corpus. In some embodiments, the text corpus can be in the form of a 2-column CSV file with N entries. In the example application, these articles had an average of 7500 words, and the user-defined criteria was a 20-page PDF document extracted from a financial institution's website outlining sustainable finance guidelines.

In some embodiments, the Document Summarization (DS) component employed Abstractive Summarization to process the financial text corpus and generate standardized-length summaries. In some embodiments, abstractive summarization distilled the contextual information by synthesizing key ideas into concise, information-dense summaries. In some situations, this can help to overcome the limitations of extractive methods that merely select existing sentences. In some situations, its capability to integrate concepts from multiple sentences makes it particularly suitable for the DS component.

In some situations, abstractive summarization with the use of generative LLMs has been effective using lower complexity models. Thus, in some embodiments, the system is configured to use machine-level generative LLMs for this task. Applying the DS component can in some situations achieve consistency across extensive document workflows. By supplying distilled text to subsequent modules, it, in some situations, reduces irrelevant and unfocused responses, thereby minimizing workflow variance and ensuring reliable results.

In some embodiments, tokens can be sized at 4 English characters per token. In other embodiments, other token sizes may be used. In one example embodiment, the obtained data was preprocessed by splitting each document into 2000 token chunks, with each chunk summarized into 250 token segments.

The following shows an example prompt for performing the summary task. {split_text} refers to each 2000 token chunk that is provided to the LLM to summarize.
Query: Given this text: {split_text} . . . generate a TL;DR.
Guidelines for your answer:
1. Include all detailed information relevant from the text.
2. Formulate concise answers, grounded on facts from context. Keep answers logical.
3. Use point form answers.
Answer: TL;DR:

In some embodiments, the summarized segments can be concatenated to form the final document summary.

Since the smallest context window of the models used in experimentation was 4096 tokens, in some embodiments, it was found that 50% of the total context or 2000 tokens, was the maximum length of each chunk that could be provided without raising runtime errors.

In some embodiments, the 250-token length for summarized segments is chosen as gains to ROUGE scoring had diminished returns past the 200-word range. 250 tokens is approximately 190 words and 12.5% of the original 2000-token chunk length. In some situations, using the “TL; DR” token in the prompt can be an effective method to incite a summary response. In some embodiments, guidelines can be used in the prompt to control the generated response structure (e.g. “Formulate concise answers”) such that the system's tokens effectively retain information.

In one study example, a summary size of 2000 tokens was initially chosen to prevent runtime errors caused by the limited context windows of generative LLMs. Given that the selected models have a maximum context window of 4096 tokens, exceeding this threshold led to memory issues and incomplete comparison outputs. To mitigate this, final document summaries were capped at 1250 tokens, ensuring sufficient token space for the comparison process. These constraints were determined based on both hardware limitations and the inherent processing restrictions of the models used. However, models still suffer from longer contexts by losing “attention,” thereby reducing the specificity needed for precise information extraction in financial document processing. This issue is even more pronounced in newer and larger models, where reliability deteriorates due to increased generalization rather than specificity. These findings reinforce the importance of smaller token sizes for summary generation to enhance information granularity.

In some embodiments, the maximum threshold length of the generated summaries was determined to be 1250 tokens to account for the minimum context window length of the LLM performing the comparison assessment as well as the hardware limitations of the experimental setup.

In some embodiments, if the final document summary is longer than a threshold length (e.g. 1250 tokens, or five 250-token segments), then the DS process can be repeated until the output summary length is below the threshold.

Previous experiments were conducted with a higher threshold length of 2500 tokens per generated summary to take full advantage of the context window length. However, the comparison task could not be performed due to memory limitations, thus the threshold size of the document summary was reduced to 1250 tokens, or 30% of the total context (i.e. 4096 tokens). Results from both the original 2500 token threshold and the new 1250 token threshold were explored to discuss the effects of shortening the available context space for abstraction summarization. In some situations, this reduction may negatively impact the performance of the DS component.

In some embodiments, the system is configured to received or access a criteria document acting as the knowledge base for the RAG process during document comparison. In some situations, it comprises a suite of user-defined parameters—for example, a set of sustainability metrics tailored for the financial domain. The system vectorizes this document and stores it in a vector database, allowing the RAG module to retrieve the top-k most relevant passages from the document summaries based on semantic similarity to the criteria. In one experiment, the criteria document for financial news articles included sustainability guidelines related to environmental impact, and the system compared these against the text corpus to identify transactions that met the sustainability criteria. The role of the criteria document is central to the system's ability to align the output with user-defined objectives. Analogous to applying the DS module to prospective documents, incorporating a criteria document within the RAG process is designed to supply the model with the most pertinent information, enhancing output specificity and accuracy.

In some embodiments, the system is configured to embedd and stored the user-defined criteria document in a vector database such that the system can retrieve passages that were most relevant to the input document summary based on a user input. In some embodiments, the criteria document is vectorized into N-character chunks. In some embodiments, the chunks have an M-character overlap. For example, in one situation the criteria document is vectorized and split into 500-character (125 tokens) chunks with a 20-character overlap. In some embodiments, the character overlap when splitting the criteria provides coherent retrieval. In some embodiments, the split size and character overlap are selected based on the best retrieval performance.

The following example prompt can be used to perform the RAG task. The information provided to {summary} is each summarized document and {target_topic} is a user-defined input to control the scope of the search.

### Query:

Given this document delimited by “:” “{summary}”: Provide the most relevant information only from the criteria that matches with the given document in terms of {target_topic}?

### Answer:

In some embodiments, the RAG is configured to retrieve relevant passages from the vector database by conducting a semantic search. The prompt given to the RAG task combines the input document summary with a simple QA query. In some embodiments, the document summary can be integrated into the RAG prompt to provide the necessary context and function as a pre-retrieval query transformation. In some embodiments, human-level LLMs are used to perform the RAG task to enable the LLM to perform STS with the retrieved passages and the supplied document summary to return the most relevant information.

In some embodiments, the system can receive a user input which is provided to the RAG to designate the focus of the search by defining a target topic that directs content retrieval. In one example, a semantic search was performed by applying the RAG prompt to the vector database to find the top-k=3 passages. k is a tunable hyperparameter that is dependent on the specified application and set of criteria. In some situations, it was found that beyond k=3, the retrieval response did not capture additional information. The top-k passages retrieved by the semantic search are an intermediary output that is presented alongside the RAG prompt as additional context for a human-level LLM to answer the query. In some embodiments, the output response of the human-level LLM is an initial comparison that is informed by relevant retrieved passages from the criteria.

The following example prompt can be used to perform the comparison assessment. The {summary} generated from the Document Summarization module and the {retrieved_text} outputted from the RAG module are provided to the prompt to perform the information retrieval and comparison tasks. The {target_topic} and {company} are provided by the user to direct the scope of comparison.

Prompt: You are an AI model assisting a Financial Analyst at {company}. Your task is to analyze the document delimited by “ ”: “{summary}” and provide a thorough, yet concise analysis in the following format:
1. Article Date: [Please input the date of the article here in MM/DD/YYYY format]
2. Participants of the transaction: [Please provide a brief description of {company}'s role in relation to the article, then list the entities involved in the transaction mentioned in the article]
3. Transaction and Transaction type: [Please indicate whether a transaction has taken place. If yes, state the type of transaction.]
4. Transaction amount in dollars: [If a transaction has occurred, please specify the amount in dollars. If no transaction, please input $0]
5. Comparison: [Based on the following criteria, delimited by “ ”: “{retrieved_text}”. Provide a concise comparison between the document and provided criteria and discuss the relevancy of the document to {target_topic}. Use specific information from the criteria and be very critical in your assessment].
6. Confidence score: [Please provide a score between 0-100 indicating the degree to which the document discusses topics related to {target_topic}. A score of 0 means the document is not at all related to {target_topic}, a score of 50 means there are many uncertainties as to its correlation to {target_topic}, and a score of 100 means the document content is entirely about {target_topic}. If the transaction amount is $0 or there is no transaction, please input a score of 0. Use your comparison to affect your decision, skepticism and implicit assumptions in the answer needed to negatively affect the confidence score.]

### Please Remember to:

1. Provide factual and concise answers. 2. Critically evaluate the information from the document. 3. Use bullet points for your answers. 4. Do not explain your thought process. 5. Do not include extra text in addition to your analysis outside of the six points of analysis. 6. “document” should only refer to the provided article document.

### Response:

In some embodiments, the Comparison Assessment (CA) component is configured to perform entity recognition, information extraction and comparison assessment tasks through the use of generative LLMs. In one example application, the information extraction tasks included the identification of financial transaction details such as whether a transaction occurred, the transaction amount and type, and the relevant participants. In some embodiments, a main task of the CA module is the comparison between the RAG output (i.e. relevant passages of the criteria) and the generated document summary. In some embodiments, complimentary to the comparison, a confidence score representing the relevancy of the document summary against a user-defined topic is generated. In some embodiments, the tasks defined in the CA module are a mix of machine-level and human-level reasoning tasks, with the most important task being the comparison of information itself. In some embodiments, the comparison task is performed using human-level LLMs.

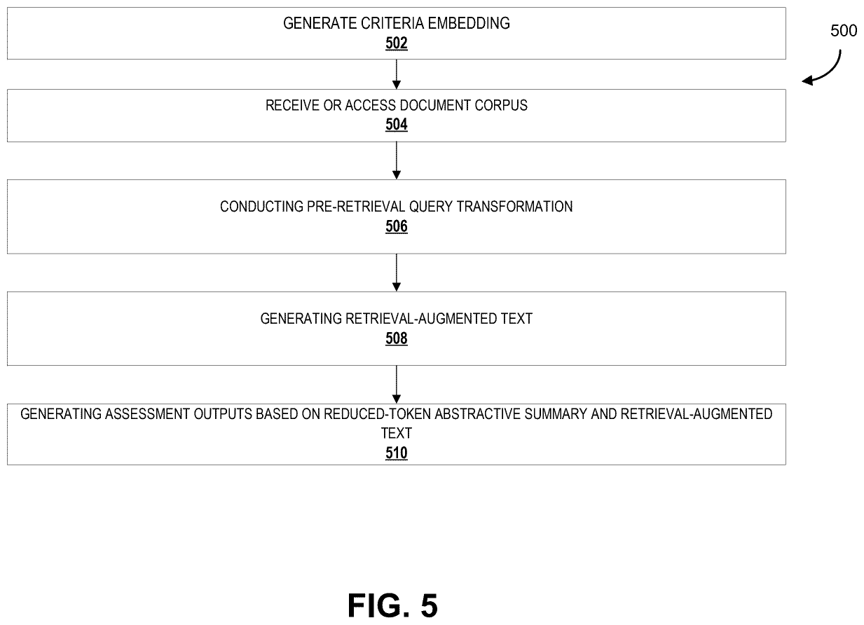

To drive the outlined tasks in the CA module, the comparison prompt in FIG. 5.3 was provided to an LLM. The comparison prompt implements multiple zero-shot prompting strategies to extract relevant information from the input context and to conduct the comparison tasks. These strategies include explicit examples, guideline specifications for finding the relevant information, and rules to direct the model response. We specifically used the phrase “Do not explain your thought process” as one of the rules to remove words that had no relevance to the comparison. Additionally, we wanted to investigate if the language model could successfully perform the task without explicitly stating its chain of thought.

In one example embodiments, the system was subjected to a baseline comparison and ablation study to compare the accuracy and clarity of the results. The ablation study highlighted the potential improvement provided by each component of the system. Additionally, the token cost difference between the various methods was compared. Currently available LLMs provide models with greatly increased input context (128k tokens) enabling these experiments. The baseline experiment was supplied with the unprocessed news document, the whole criteria document, and identical prompts used in the ASC ²End system to generate responses. The ablation study was performed with the section of focus removed from the ASC ²End pipeline. GPT 4o was applied to the original model, baseline and all ablation studies to maintain testing consistency and comparison. Only 50 randomized data points, a small subset of the original dataset, were used for the baseline and ablation study.

The experiment was completed on an A6000 GPU with 48 GB of RAM. Open-source models were loaded into local memory using the GPTQ method where the model parameters were quantized to decrease the total memory load. Model hyper-parameters are shown in Table 2: Hyper-parameters used for each model. Models were divided into Machine-level LLMs (GPT 3.5, Mistral 7B, Llama 2 7B, 13B) and Human-level LLMs (GPT 4, Llama 2 70B).

| LLM Class | Temperature | Max New Tokens |
|---|---|---|
| Machine-level | 0 | 250 |
| Human Level | 0 | 500 |

Models were set to a temperature of 0 to maintain the results' reproducibility and keep output formats consistent for all candidate documents. ASC ²End was developed using the LangChain framework for all API calls and for managing the vector database requests. The embedding model used for the vector database was the Beijing Academy of Artificial Intelligence (BAAI)'s “bge-base-en-v1.5” as it was the best performing open-source embedding model for the model size. Additionally, the BAAI model outperformed OpenAI's paid “text-embedding-ada-002” model on the Massive Text Embedding Benchmark (MTEB) leaderboard. The RAG task for this system is powered by FAISS (Facebook AI Similarity Search) acting as the vector database, due to its efficiency in performing similarity search.

In some embodiments, the system is configured to summarize documents in bulk before subsequent framework steps to create concise base-level inputs essential for driving the RAG and CA components. The DS component allows flexible summarization methods to accommodate varying workflow requirements. In one experiment involving over 1,000 news articles, applying DS before other system workflow components significantly reduced input token usage for downstream tasks, improved overall processing throughput, and lowered computational costs associated with document processing. In some situations, reducing token input results in better downstream LLM performance.

The model performances on both the abstractive summarization task and the comparison assessment task were evaluated using the ROUGE score and survey answers, respectively. The performance of the example ASC ²End framework was compared to baseline methods and an ablation study was performed to emphasize the impact of each defined component.

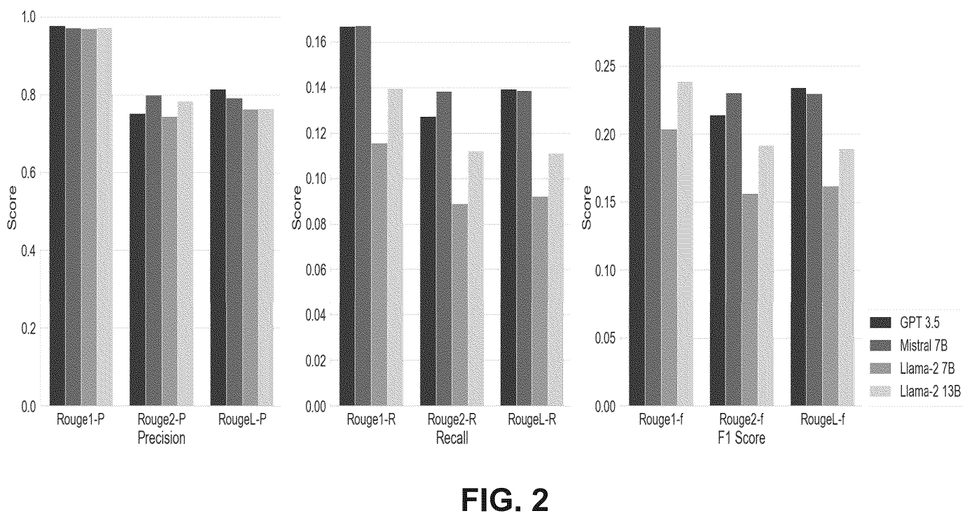

As illustrated in FIG. 2, the scores presented for abstractive summarization are the averaged ROUGE values across the given corpus of 1253 documents. There are two sets of summarization results, the first using a maximum output length of 2500 tokens and the second using 1250 tokens. Both sets of results are presented to highlight different relative model performances on a limited context window.

ROUGE is calculated based on the text overlap using the calculated precision and recall values. The score ranges from 0 to 1, where 0 indicates poor similarity and 1 indicates strong similarity between the summary and reference text. ROUGE can be evaluated with any number of n-grams. The chosen evaluations for this experiment were unigram (n=1), diagram (n=2), and the longest sub-sequence of text (n=L) for evaluation. Unigram performance measures the number of single words that match the original document, reflecting how overall information was retained. Conversely, diagram and sub-sequence performance measure the quality of semantic meaning retained in the summary. The ROUGE formulas for calculating the unigram & diagram (1-3) and the L-scores (4-6) are presented below.

$$ROUGE - {1}_{precision} = \frac{cand . unigram ⋂ ref . unigram}{\vert cand . unigram \vert} \qquad ( 1 )$$

$$ROUGE - {1}_{recall} = \frac{cand . unigram ⋂ ref . unigram}{\vert ref . unigram \vert} \qquad ( 2 )$$

$$ROUGE - {1}_{F 1} = 2 \cdot \frac{precision \cdot recall}{precision + recall} \qquad ( 3 )$$

ROUGE-1 Equations. Candidate text (cand.) refers to the summarized document, and the reference text (ref.) refers to the original text. ROUGE-2 uses diagrams instead of unigrams

$$ROUGE - {L}_{precision} = \frac{LCS ( cand . , ref . )}{\#words in cand .} \qquad ( 4 )$$

$$ROUGE - {L}_{recall} = \frac{LCS ( cand . , ref . )}{\#words in ref .} \qquad ( 5 )$$

$$ROUGE - {L}_{F 1} = 2 \cdot \frac{precision \cdot recall}{precision + recall} \qquad ( 6 )$$

ROUGE-L Equations. Candidate text (cand.) refers to the summarized document, and the reference text (ref.) refers to the original text.

In the 2500-token length summarization results (FIG. 2), unigram (n=1) precision across all four machine-level models was competitive with scores close to 1. A significant decline in performance in both precision and recall was observed when the remaining n-gram performances were compared to the unigram (n=1) performance. Due to paraphrasing, word-pair overlaps and sub-sequence matching were not maintained in abstractive summarization, leading to lower scores in diagram (n=2) and subsequence (n=L) scores. The recall score is based on the amount of text overlap between the candidate and reference text compared to the total length of the reference text. Summarization shortened the length of the source documents to less than 12.5% of its initial length, and a shorter context length meant less text to compare for the recall score. Thus, the recall score in every case for all four models was significantly lower than the precision scores. In terms of models, Mistral 7B displayed a strong score in the ROUGE-2 scenario, beating GPT 3.5 and the Llama models (FIG. 2). Mistral 7B also has competitive results compared to GPT 3.5 in ROUGE-1 and ROUGE-L scoring and is an open-source model, making it an economical option for larger-scale workflows. It was also observed that there were significant performance decreases in the recall scores of the Llama models. Llama model outputs are more lengthy and are more likely to generate sequences of text that may not be relevant to the summary, thus negatively affecting the recall score.

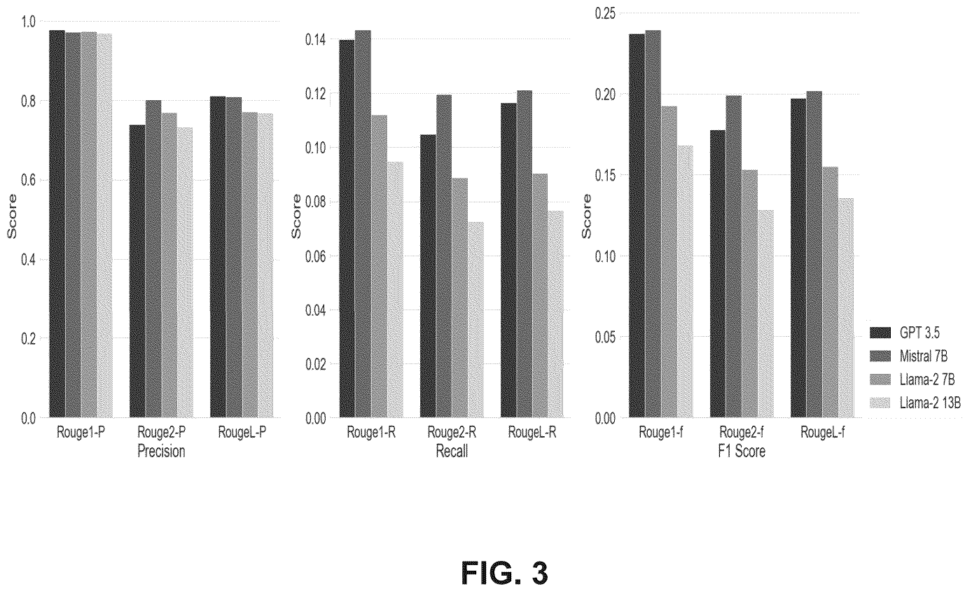

The 1250-token length summarization task (FIG. 3) was conducted to ensure runtime success and to analyze the losses in ROUGE scoring for a shorter output summary length. A direct comparison in the ROUGE values between the two summarization tasks was made the table below. The precision of all four models was almost identical to the first summarization task, implying that the context of the information did not change during the shortening of the summaries. The recall scores decreased by at least 2%, with the greatest decrease in recall for the Llama-2 13B model. As a result, the larger parameter Llama model was deemed not suited for summarization tasks with token limitations due to its verbosity. Llama-2 7B had similar scores across both summarization tasks but still performed significantly worse than the top models. From this 1250-token length experimentation, we found that the top-performing models from the first summarization task experienced negligible changes in performance despite the shortened summary length. Mistral 7B outperformed GPT 3.5 in every recall measure and had improved overall F1 scoring. In addition, Mistral 7B recall scores did not take a severe performance hit in the second summarization task. Therefore, Mistral 7B was the most suitable machine-level LLM to employ in the DS module for running abstractive summarization.

| GPT | GPT | Mistral | Mistral | Llama-2 | Llama-2 | Llama-2 | Llama-2 |
|---|---|---|---|---|---|---|---|
| 3.5-1 | 3.5-2 | 7B-1 | 7B-2 | 7B-1 | 7B-2 | 13B-1 | 13B-2 |

Precision

| | | | | | | | | |
|---|---|---|---|---|---|---|---|---|
| n = 1 | 0.978 | 0.978 | 0.971 | 0.972 | 0.970 | 0.974 | 0.973 | 0.970 |
| n = 2 | 0.751 | 0.740 | 0.799 | 0.801 | 0.744 | 0.770 | 0.783 | 0.734 |
| n = L | 0.815 | 0.812 | 0.793 | 0.808 | 0.763 | 0.772 | 0.766 | 0.770 |

Recall

| | | | | | | | | |
|---|---|---|---|---|---|---|---|---|
| n = 1 | 0.167 | 0.140 | 0.167 | 0.143 | 0.116 | 0.112 | 0.139 | 0.095 |
| n = 2 | 0.127 | 0.105 | 0.138 | 0.120 | 0.089 | 0.089 | 0.112 | 0.073 |
| n = L | 0.139 | 0.116 | 0.139 | 0.121 | 0.092 | 0.090 | 0.111 | 0.077 |

F1

| | | | | | | | | |
|---|---|---|---|---|---|---|---|---|
| n = 1 | 0.280 | 0.237 | 0.278 | 0.240 | 0.204 | 0.193 | 0.239 | 0.169 |
| n = 2 | 0.214 | 0.178 | 0.230 | 0.199 | 0.157 | 0.153 | 0.192 | 0.129 |
| n = L | 0.234 | 0.197 | 0.230 | 0.202 | 0.162 | 0.155 | 0.190 | 0.136 |

ROUGE scores of the first and second summarization experiments. The model performance from the first and second summarization assessments are indicated by −1 and −2, respectively. Bolded values reflect the best score in the second summarization assessment.

The results of the second summarization task with the minor shifts in ROUGE precision scores were indicative that semantic context was still maintained. The shorter context demonstrates that using abstractive summarization with different context lengths may not negatively affect the overall performance of the pre-retrieval step in the system. In some embodiments, the shorter context may enable the scaling of the process for larger datasets, as shorter output contexts are more financially and computationally efficient. The investigation of several prominent LLMs in applying the ASC ²End framework demonstrates a preliminary benchmark that is beneficial in understanding the expected performance of similarly-sized models and helps with model selection for other implementations.

When evaluating the human-level LLMs performing the CA tasks, the model was evaluated based on the clarity of model output, accuracy of model response, and the presentation of information. The scores presented in the comparison assessment reflect the human-annotated scores of 21 survey participants. For this section, Llama 2 70B will be called Llama 2.

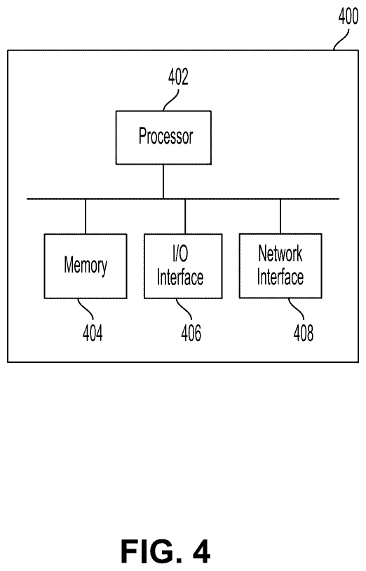

In consideration of the performance of the system, outputs for both qualifying and a non-qualifying candidate articles from the Llama 2 and GPT-4 comparison assessments were compared. Both models generate outputs of similar quality when analyzing a qualifying transaction, with differences primarily in verbosity and presentation style. In on example, a key distinction is that Llama 2 successfully identifies the article date, whereas GPT-4 does not. For the non-qualifying transaction shown in FIG. 4.2, Llama 2 demonstrates strong information retrieval capabilities, extracting relevant details directly from the candidate text. In contrast, GPT-4 exhibits a more rigorous comparison process, incorporating a structured approach to evaluating relevance and generating a confidence score. Overall, Llama 2 tends to produce more detailed and expansive responses, while GPT-4 offers a more concise and systematic analysis. Due to Llama 2 providing more verbose responses and less systematic analysis, it tends to provide more false positives, reflected in survey responses. These findings highlight the models' respective strengths in extracting key information and justifying confidence scores.

| | | Correctly | Correctly | | | |
|---|---|---|---|---|---|---|
| | Correctly | Stated | Stated | | Correct | |
| | Stated | Transaction | Transaction | Correct | Confidence | Overall |
| | Roles | Type | Amount | Comparison | Score | Score |
| Llama 2 | 0.760 | 0.875 | 0.825 | 0.432 | 0.562 | 3.453 |
| GPT-4 | 0.893 | 0.925 | 0.830 | 0.698 | 0.810 | 4.155 |

GPT 4 performed better than Llama 2 by 0.7 points on average and scored higher in every category. GPT 4 scored 0.2-0.3 points greater than Llama 2 in assessing the comparison and providing reasoning to justify its confidence score. Score disparity may be attributed to the different reasoning abilities of the two models. Scores on identifying stated information were more similar between Llama 2 and GPT 4, with a 0.05-0.1 point difference between the first three categories focusing on retrieving information from the input context. The reason for the similar scores is attributed to the lower task complexity of NER tasks.

According to the survey results, there are major differences between the human-level reasoning abilities of the models. Llama 2 obtained an unimpressive score of 0.432 when evaluating the correct comparison given a candidate summary and the retrieved passages from the user-defined criteria. Llama 2 struggled to identify the sentiment of the candidate text and it conformed the candidate sentiment to the sentiment of the retrieved reference text. The model's inability to perform the comparison task resulted in misidentifying and hallucinating the candidate text's conformity to the target topic. Similarly, when providing reasoning for its confidence score on the target topic, Llama 2 obtained a low score of 0.56.

On the other hand, GPT 4 excelled in justifying its generated confidence score, with an average score of 0.81. This score indicates that the GPT 4 model accurately determined the sentiment of the candidate text and used reasoning to provide a valid response. The score also reflected that GPT 4 explained its reasoning succinctly, so the survey participants agreed with the response. GPT 4 obtained a score of 0.698 for its ability to identify the correct comparison. Compared to Llama 2's 0.431, GPT 4 was better at accurately identifying sentiment and making accurate comparisons between the candidate and reference texts.

The comparison score reflects the practical capabilities and quality of responses generated by the example system. The performance disparity between GPT 4 and Llama 2, as seen in the table demonstrates the importance of model selection and the complexity of the comparison task. The GPT 4 results show that the system successfully implemented a text comparison solution, and the Llama 2 results show clear shortcomings in a cohesive text comparison. The text comparison task is a complex operation that requires the LLM to “understand” the provided texts and generate relevant comparisons and discussions. The GPT 4 result indicates that the pre-retrieval RAG process with abstractive summarization provided relevant information to the model and enabled full function of the system.

The baseline experiment of performing the comparison task was completed using GPT 4o. The baseline experiment was impossible to perform until the existence of larger context models. We scored the performance of the baseline model based on its accuracy to provide specific, context-driven comparisons in its response. The results generated from the baseline showed expected success in completing NER tasks such as date and company recognition driven through prompt engineering. The test data sample included one positive document that fit the targeted search focus, which the baseline successfully identified. However, it was observed that the dates extracted in the baseline experiment were associated with the published date, not the transaction date mentioned within the article. For runtime and token usage performance, the baseline model required 825% more tokens than the ASC ²End model with only a decrease in runtime by 3.8%, summarized in the table below. The baseline experiment had an accuracy of 80%, 14% lower than the ASC ²End model in evaluating the comparison tasks. The comparison generated by our system was more concise and specific compared to the baseline experiment. Specific comparison topics regarding the context of the article were discussed in the outputs of the ASC ²End system but not in the baseline.

| | % Token | % Runtime | |
|---|---|---|---|
| Description | Difference | Difference | Accuracy |
| Baseline | +824.9% | −3.8% | 80% |
| No DS | +290.8% | +25.2% | 94%* |
| No RAG | +526.4% | −20.5% | 78% |
| No CA | −65.5% | −57.3% | 8% |
| Model | 2277.28 | 6 m 5 s | 94% |

The baseline experiment highlighted some future improvements to the ASC ²End system, with a focus on stronger specificity in abstraction. Arguably, using abstractive summarization requires another LLM, but it was completed locally in this experiment on an open-source model for a lower financial cost. If desired, summarization could still be done with GPT 4o with fewer tokens than the baseline. Additionally, the difference in token usage is significantly noticeable in larger workflows, creating a much larger financial burden and unnecessarily using computational resources to obtain less desirable results when applying only the baseline experiment. Additionally, SOTA LLMs like GPT 4o may not be feasible for access to perform this comparison task, namely in organizations and academic settings where models have a 4000-token limit. The ASC ²End system provides a cost and computationally-effective solution to text comparisons at scale while outperforming the presented baseline.

While not all are necessarily critical, each component of the system architecture provides a function and/or an improvement in the generation the final output analysis for each document. To illustrate example embodiments where different components are not present in the system, ablation studies were performed on a small subset of data to demonstrate the differences in output quality and token usage in each ablation study.

In an example embodiment where the DS component is not included in the system, the performance difference of applying abstractive summarization was investigated. This ablation study had a 25% increase in runtime and a 291% increase in token usage compared to our model, seen in the table above. The cause of the increased run time and token usage was due to the varying article lengths, resulting in more tokens used during inference. During accuracy scoring, it was observed that even though 94% of the articles were correctly identified and analyzed, there was no change in the retrieved information across different articles of focus. The issue was particularly evident with longer context documents, where retrieval struggled to provide robust comparisons to the criteria document. This ablation experiment failed to generate unique comparison points across the tested data points. In our system, the distilled data provided by the DS module effectively directs the RAG search by providing significantly less input context to compare to for retrieval. The effectiveness of providing distilled and directed data is further amplified by the observations made on the output quality of this ablation experiment.

In an example embodiment where the RAG component is not included in the system, the effects of specific search compared to providing the entire document for comparison were demonstrated. This ablation task used 526% more tokens than the ASC ²End model but had a runtime difference of −21%, as seen in the table above. This study observed that the comparison discussion had a lower accuracy of 78% compared to our model. This observation can be attributed to using the LLM to search for relevant points of comparison instead of having RAG direct the context for comparison. Removing the RAG module required loading the entire 20-page criteria comparison document for each inference. The accuracy results reflect a gap in non-RAG approaches to direct evidence-based text comparisons and instead output generic results due to extended context. The application of the RAG module in our system provided directed context for the CA module, instead of depending on the LLM itself to locate the relevant information in the provided document for the comparison.

Previous RAG-focused architectures focus on different forms of information retrieval to optimally answer the user query in closed domain QA. Applying RAG is very powerful for obtaining in-context information to enhance the LLM's response, but RAG processes are optimized for only QA-related tasks. The removal of the CA component showed the implications of its effectiveness in examples of the present system. For this experiment, the prompt from the CA component was modified and combined with the RAG prompt to have the RAG complete the CA component'stask. From experimentation, this study took 65% less tokens to complete and 57% less time when compared to our model, seen in the table above. However, the outputted comparison discussion and the generated confidence score were incorrect and reflected in its 8% accuracy score. It was observed that the comparison discussion conclusion consistently contradicted the generated confidence score, reflecting a high degree of hallucination not observed in any other experimentation. The hallucination is driven by the retrieved information, not the input context, indicating that a RAG-only pipeline is inadequate for text comparison. In example embodiments of the system, the CA component restates the article summary and only queries the RAG module to search for the relevant passages, not conduct the comparison. Within the RAG module, conducting the search and comparison analysis in one step poses the risk of hallucination due to the searched information affecting the LLM's available context.

TABLE
Results of a system ablation study on 50 randomly sampled data
points. The percentage difference in token usage and runtime compared
to our model was used to highlight the differences in model performance.
The accuracy of each study was measured by the model's ability
to specifically determine the areas of comparison to the criteria
document and correctly assign a confidence score based on its
comparison. the presented accuracy is the percentage of the 50
test samples properly identified, labelled either 0 or 1 based
on specificity and correctness. Raw values for the model are reported
to provide the scale of the experiment.

| Description | % Token Difference | % Runtime Difference | Accuracy |
|---|---|---|---|
| Baseline | +824.9% | −3.8% | 80% |
| No DS | +290.8% | +25.2% | 94%* |
| No RAG | +526.4% | −20.5% | 78% |
| No CA | −65.5% | −57.3% | 8% |
| Model | 2277.28 | 6 m 5 s | 94% |

*Accuracy defined in the No-DS ablation study does not reflect model reasoning due to identical comparison points for different articles

In some embodiments, the system may provide large-scale automation capabilities to quickly perceive publicly posted information. In some situations, aspects of the system may provide insights regarding the conformity of a candidate document corpus to the user-defined criteria. Large-scale automation of information comparison may results in time-savings, providing more opportunities for users to perform meaningful analyses on distilled data.

As the quality, accuracy, and inference throughput of LLM-driven text analysis tools improve, the system may substitute or otherwise incorporate these new tools. In some embodiments, the system may be applicable by implementing prompt engineering and RAG to obtain the desired results, removing many dependencies on pre-existing domain-specific data. In some embodiments, the system and methods may be intuitive and may eliminate the need for LLM expertise during system operation while leveraging the user's expertise to interpret the results. In some embodiments, the system utilizes an unconventional approach to applying RAG as a smart retrieval system for systematic analyses contrary to endpoints for context-driven QA tasks.

| LLM | Min/Document | Relative Runtime |
|---|---|---|
| Llama 2 70B | 1.18 | 1 |
| GPT 4 | 0.38 | 0.32 |

From our experimental results in the table above, GPT 4 can complete a comparison assessment in 0.38 minutes demonstrating the system's scalability to much larger datasets and workflows. The use of Llama 2 70B is possible, however, it performs significantly slower and there are significant performance declines that were outlined above. The comparison between these two models showcases that the performance of the system may be improvable by substituting more current and capable models. Additionally, the GPT 4 model performance demonstrates that the time complexity of the system is low and is efficient for completing large workflows with thousands of articles and documents to process, with many opportunities for improvement as LLMs become more advanced.

In some situations, the system may eliminate redundancies of traditional human textual analysis and may decrease the amount of time required to extract and compare relevant information from documents. The system may enable users to quickly access relevant topics and details of documents on a larger scale, which can influence the speed at which decisions are made. This may be beneficial in the financial domain where decisions are time-sensitive and require accurate, publicly available information to aid in decision-making. Opening up information availability to a larger population also implies a better understanding of the underlying actions of corporations and governments that were previously “hidden in plain sight”. With the application of the system, relevant information is properly distilled to the user, removing irrelevant and misleading information.

In some embodiments, the system is designed to function with naive generative LLMs as they can adapt to different knowledge domains by applying zero-shot prompting techniques. In some embodiments, the prompt engineering structure used in the system can be modified to support few-shot prompting strategies for applicable knowledge domains and specific use cases where applied examples were designed. Additionally, the zero-shot prompting structure of the system can be modified to determine different focuses of analysis. The system was designed to be robust by enabling the ability to process various data sizes through our abstractive summarization and criteria embedding components. These components were designed to facilitate widely reproducible results with different scopes of analysis.

In some situations, the system's domain flexibility is one of its strengths, allowing the system to adapt to a wide range of use cases with minimal modification. In the legal domain, for example, the system could compare existing regulations against new legislative changes. The CE component would be updated to process legal terminology, and the criteria document would contain the specific provisions of the new law. The RAG component would then retrieve relevant legal precedents and specifications that best match the prospective document summaries, enabling the system to identify compliance or gaps in regulation. This process is similar across domains, where the CE and RAG component would be customized for each domain's vocabulary and requirements.

While the examples described herein have been on financial data, the system is adaptable to a wide range of domains. For instance, in the healthcare sector, the system could automate the comparison of patient treatment data against established clinical guidelines, improving the speed and accuracy of decision-making. In legal analysis, the system could be applied to compare newly introduced regulations with existing organizational policies to ensure regulatory compliance or even automate the analysis of case law. In the pharmaceutical industry, the system could compare emerging research findings with pre-existing drug efficacy data, helping researchers identify gaps and areas for further investigation. This cross-domain flexibility is enabled by the system's use of zero-shot prompting, context distillation and context injection, which allows it to adapt to new fields with minimal fine-tuning.

In some embodiments, abstractive summarization task is performed to shorten the input context while retaining the relevant information for analysis. In some embodiments, prompts are designed to request specific information to be retained and direct the LLM through zero-shot prompting to extract the information of relevance. By providing more explicit instructions, minor perturbations may have a lower impact on the summary performance. Additionally, in some situations, the system may be capable of text comparisons while being time and computationally-efficient. In previous methods, extensive fine-tuning of an LLM is required to generate an improved summary quality. However, the trade-off to the improved summary quality is the increased investment of computational and time resources. In some situations, some example embodiments exhibit strong information and context retention through the prompting structure without applying model finetuning or additional context-related data splitting.

In other approaches, methods for enhancing data along the RAG workflow have been developed to improve the implementation of RAG with LLMs. In contrast, some example systems perform an abstractive summarization step as a pre-retrieval process for RAG as it “rewrites” the context part of the query for our system. Additionally, the system is configured to utilize the RAG as a method to inject the most relevant context to the last stage of the pipeline, in the CA module.

In some embodiments, abstraction is used to shorten article lengths and preserve context, enabling similar analyses to baseline methods while minimizing resource use. In contrast, other approaches apply much shorter passages of the original context to leverage the RAG search, functioning very similar to a QA-based task. These other approaches fragment the original article and do not provide a holistic approach and analysis of the desired article. In some embodiments, the present system is configured to apply abstraction on the whole document to retain the complete context of the input document for the RAG process and apply it to the RAG and CA modules. In some embodiments, the pre-retrieval process is more complex than other approaches as the distilled article is provided instead of portions of text. The results demonstrate success, in some situations, in providing context-driven RAG outputs through our pre-retrieval pipeline.

FIG. 5 is a flow chart showing aspects of an example computer-implemented method 500 which may be executed on one or more computing devices 400 or systems as described herein or otherwise. In some embodiments, some or all aspects of the example method 500 can be based on some or all of the features described or referenced herein or otherwise.

At 502, in some embodiments, a computing device or system provides one or more input interfaces for receiving, generating, or otherwise accessing a criteria embedding. In some embodiments, the computing device can access a criteria document which can be an electronic document including text such as unstructured text and/or natural language. In some embodiments, the criteria document can be saved and accessed as a document. In some embodiments, the criteria document can be a block of text inputted into an input field on a user interface, or which is otherwise received via an interface of the computing device. In some embodiment, the criteria document includes text which describes the criteria by which a corpus of documents is to be evaluated by the system.

The criteria can include, for example, user-defined criteria for determining the sustainability of an investment; criteria for filtering news articles, regulatory requirements, criteria for gathering information relevant to a business dashboard, and/or generally any criteria for assessing any type of information or document. Irrespective of the type of information being processed, the methods and systems described herein provide technical solutions for processing a large corpus of documents for potentially any criteria-assessing purpose, and in certain situations overcome technical challenges or shortcomings of other systems as referenced herein or otherwise.

In some embodiments, the computing device generates 502 criteria embedding form the criteria document. In some embodiments, the criteria embedding component(s) generate a vector representation of the criteria embedding and can store the criteria embedding in a vector database. In some embodiments, the vector database is any file or data structure suitable for storing the vector representation for access and/or use by the downstream functions.

At 504, the computing device or system receives or access a document corpus. In some embodiments, the document corpus is a corpus of electronic files stored or otherwise accessible by the system. In some embodiments, the document corpus comprises a collection or series of documents to be processed by the system. In some embodiments, the corpus of documents which are processed/to be processed by the system can be described as a throughput of documents which pass through the system at one time or in an ongoing manner.

In some embodiments, the document corpus is a collection of documents scraped or otherwise received by the system from the internet or other data sources. In some embodiments, the computing system can continuously receive, update, or otherwise update the document corpus through continuous or periodic scraping, identification and/or receipt of new documents. In some situations, through the ongoing receipt or access of new documents in the corpus, the system/computing device can provide ongoing outputs, can update responses or can otherwise generate new or updated alerts of outputs as new documents are added to the corpus.

In some embodiments, the document corpus includes documents against which the criteria in the criteria document are to be assessed.

At 506, the system/computing device is configured to conduct a pre-retrieval query transformation. In some embodiments, the query transformation includes generating a reduced-token abstractive summary data set for each document in the corpus of documents. In some embodiments, the reduced-token abstractive summary data encapsulates information from the original document in a form which requires fewer tokens than the original document. In some embodiments, the generation of the abstractive summary data set includes conducting a abstractive summarization (in contrast to an extractive summarization). In some embodiments, this includes generating new sentences or phrases, or otherwise generating new sets of words/tokens based on the original document (rather than simply extracting a subset of the sentences of the original document). In some embodiments, the system/computing device is configured to provide parameters to a first language model in the DS component to generate abstractive summary data which includes specific information based on the desired output of the system.

In some embodiments, the pre-retrieval query transformation includes conducting a semantic search using retrieval augmented generation to identify relevant criteria data from the criteria embedding vector database based on the reduced-token abstractive summary data set.

In some embodiments, the relevant criteria data from the pre-retrieval query transformation represents a distilled encapsulation of the relevant context of the document. In some embodiments, this distilled encapsulation provides a token-efficient mechanism for processing the potentially large corpus of documents.

At 508, the system/computing device is configured to generate retrieval-augmented text. In some embodiments, this includes performing, with a second language model, semantic textual similarity with the identified criteria data and the previously-referenced reduced-token abstractive summary data set.

At 510, the system/computing device is configured to generate a set of assessment outputs based on the reduced-token abstractive summary data set and the retrieval-augmented text. In some embodiments, the outputs are stored in a computer-readable medium for downstream processing and/or are outputted to an output device or destination.

In some embodiments, the generating the set of assessment outputs includes generating an assessment corpus. In some embodiments, the assessment corpus can include a reduced data set which is based on the original corpus of documents but has been reduced in size and/or complexity based on the criteria document. In some embodiments, the assessment corpus is smaller and/or contains more relevant/filtered information in comparison to the original corpus of documents.

In some embodiments, generating the set of assessment outputs includes generating an output based on a query on the criteria document and the corpus of documents.

In some embodiments, generating the set of assessment outputs includes providing an identification of a subset of the documents in the corpus of documents which are relevant to a query and/or the criteria document. For example, in one example embodiments, the system was able to distill a large corpus of documents to a subset of criteria relevant documents which represented 2% of the original document corpus.

In some embodiments, generating the set of assessment outputs includes generating explanation text which provides natural language text indicating why a document in the corpus is relevant or comparable to the criteria or an inputted query. For example, in some example embodiments, the system outputs an identification of a document along with a text explanation that the document is relevant/related because it mentions X. Conversely, in some example embodiments, the system outputs explanations for documents which are not identified as relevant because the document mentions none of X, Y, Z.

In some embodiments, generating the set of assessment outputs includes generating and outputting a confidence score for an identified document in the corpus.

In some embodiments, for throughputs of documents which are periodically or continuously updated, generating the assessment outputs can include generating a communication or alert which indicates when a new relevant document has been identified.

FIG. 4 is a schematic diagram of a computing device 400, one or more of which may be used to implement various elements of computing systems, architecture, and methods described herein or otherwise.

As depicted, computing device 400 includes at least one processor 402, memory 404, at least one I/O interface 406, and at least one network interface 408.

Each processor 402 may be, for example, any type of general-purpose microprocessor or microcontroller, central processing unit, graphics processing unit, specialize hardware unit (e.g. neural processing unit/AI accelerator/deep learning processor), a digital signal processing (DSP) processor, an integrated circuit, a field programmable gate array (FPGA), a reconfigurable processor, a programmable read-only memory (PROM), or any combination thereof.

Memory 404 may include a suitable combination of any type of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) and/or the like; as well as hard disk drives, solid-state drives, flash memories, and/or the like.

Each I/O interface 406 enables computing device 400 to interconnect with one or more input devices, such as a keyboard, mouse, camera, touch screen and a microphone, or with one or more output devices such as a display screen and a speaker.

Each network interface 408 enables computing device 400 to communicate with other components, to exchange data with other components, to access and connect to network resources, to serve applications, and perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. Wi-Fi, WiMAX), SS7 signaling network, fixed line, local area network, wide area network, and others, including any combination of these.

For simplicity only, one computing device 400 is shown but systems may include multiple computing devices 400. The computing devices 400 may be the same or different types of devices. The computing devices 400 may be connected in various ways including directly coupled, indirectly coupled via a network, and distributed over a wide geographic area and connected via a network (which may be referred to as “cloud computing”).

For example, and without limitation, a computing device 400 may be a server, network appliance, embedded device, computer expansion module, personal computer, laptop, smartphone device, or any other computing device capable of being configured to carry out the methods described herein.

In some embodiments described herein or otherwise, the example systems are configured with two different levels of task performance, machine and human level, ensuring system tasks were performed by the most appropriate model. In some situations, the system is designed to perform text comparisons at scale through the applications of LLMs and surrounding technologies. The system was designed for large-scale text comparisons, minimizing information loss and addressing shortcomings in existing approaches. Current approaches require greater investments in time, data, and computational complexity to drive the success of their proposed methods. Additionally, existing pre-retrieval methods focus on simplifying the input for RAG instead of reducing the input size. In some embodiments, the currently described system applies a pre-retrieval RAG pipeline and system through abstractive summarization and RAG to remove dependencies on domain-specific training data to decrease runtimes and computational complexity.

In some embodiments, the example document summarization component results demonstrate the effectiveness of text distillation in preserving semantic meaning. These results reinforce the application of abstractive summarization as a pre-retrieval step for RAG to present relevant information and minimize loss. It was found that Mistral 7B provided the best ROUGE results for summarization in shorter contexts. Survey responses indicate GPT-4 has superior reasoning and text comparison abilities compared to Llama 2-70B. Additionally, the strong survey response scoring on GPT 4's comparison assessment further reflects the effectiveness of the system in generating high-value assessment reports on financial news documents.

In some embodiments, the system assists in the decision-making process and can save time for analyst professionals requiring specific and semantically related information concealed in each document of a large corpus. In some situations, the system provides an automated systematic approach to existing text comparison strategies while removing dependencies on the human operator.

The foregoing discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

The embodiments of the devices, systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the foregoing discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements.

The embodiments and examples described herein are illustrative and non-limiting. Practical implementation of the features may incorporate a combination of some or all of the aspects, and features described herein should not be taken as indications of future or existing product plans. Applicant partakes in both foundational and applied research, and in some cases, the features described are developed on an exploratory basis.

Of course, the above-described embodiments are intended to be illustrative only and in no way limiting. The described embodiments are susceptible to many modifications of form, arrangement of parts, details and order of operation. The disclosure is intended to encompass all such modification within its scope, as defined by the claims.

What is claimed is:

1. A method for a computer-implemented natural language processing architecture, the method comprising:
generating a criteria embedding from a criteria document containing natural language or otherwise unstructured text, and storing the criteria embedding in a vector database;
receiving or accessing an electronic document corpus comprising a throughput of electronic documents;
for each individual document in the throughput of electronic documents:
generating a reduced-token abstractive summary data set for the individual document with a first language model;
conducting, using retrieval augmented generation, a semantic search to identify relevant criteria data from the criteria embedding vector database based on the reduced-token abstractive summary data set;
generating, with a second language model, retrieval-augmented text by performing semantic textual similarity with the identified criteria data and the reduced-token abstractive summary data set of the individual document; and
generating, with a third language model, a set of assessment outputs based on the reduced-token abstractive summary data set of the individual document and the retrieval-augmented text.

2. The method of claim 1 wherein generating the reduced-token abstractive summary data set for each individual document in the throughput of electronic documents comprises:
dividing the individual document into token chunks;
separately generating a reduced-token data subset for each of the token chunks with the first language model; and
concatenating the reduced-token data subset for each of the token chunks to generate the reduced-token abstractive summary data set for the individual document.

3. The method of claim 1 wherein generating the set of assessment outputs comprises:
generating, with the third language model, comparison text including natural language text indicating a comparison between the individual document and an inputted target topic based on the reduced-token abstractive summary data set and the retrieval-augmented text as criteria.

4. The method of claim 3, wherein generating the set of assessment outputs comprises generating a confidence score indicating a degree to which the individual document includes text related to the inputted target topic.

5. The method of claim 1 comprising: storing or outputting the sets of assessment outputs for each of the individual documents as an assessment corpus.

6. A system for a computer-implemented natural language processing architecture; the system comprising:
a processor; and
a non-transitory memory storing one or more sets of instructions that when executed by the processor, configures the system for:
generating a criteria embedding from a criteria document containing natural language or otherwise unstructured text, and storing the criteria embedding in a vector database;
receiving or accessing an electronic document corpus comprising a throughput of electronic documents;
for each individual document in the throughput of electronic documents:
generating a reduced-token abstractive summary data set for the individual document with a first language model;
conducting, using retrieval augmented generation, a semantic search to identify relevant criteria data from the criteria embedding vector database based on the reduced-token abstractive summary data set;
generating, with a second language model, retrieval-augmented text by performing semantic textual similarity with the identified criteria data and the reduced-token abstractive summary data set of the individual document; and
generating, with a third language model, a set of assessment outputs based on the reduced-token abstractive summary data set of the individual document and the retrieval-augmented text.

7. The system of claim 6, wherein generating the reduced-token abstractive summary data set for each individual document in the throughput of electronic documents comprises:
dividing the individual document into token chunks;
separately generating a reduced-token data subset for each of the token chunks with the first language model; and
concatenating the reduced-token data subset for each of the token chunks to generate the reduced-token abstractive summary data set for the individual document.

8. The system of claim 6, wherein generating the set of assessment outputs comprises:
generating, with the third language model, comparison text including natural language text indicating a comparison between the individual document and an inputted target topic based on the reduced-token abstractive summary data set and the retrieval-augmented text as criteria.

9. The system of claim 6, wherein generating the set of assessment outputs comprises generating a confidence score indicating a degree to which the individual document includes text related to the inputted target topic.

10. The system of claim 6, wherein the one or more sets of instructions configure the system for storing or outputting the sets of assessment outputs for each of the individual documents as an assessment corpus.

11. The system of claim 6 wherein the processor and non-transitory memory include data and/or instructions to provide a multitier natural language processing architecture including a first tier and a second tier of natural language processing models; the second tier including at least one natural language processing model which is larger than the natural language processing models of the first tier.

12. The system of claim 11 wherein the first tier includes the first language model; and the second tier includes the second language model.

13. A non-transitory computer-readable medium or media having stored thereon machine interpretable instructions which, when executed by a processing system, configures the processing system for generating a criteria embedding from a criteria document containing natural language or otherwise unstructured text, and storing the criteria embedding in a vector database;
receiving or accessing an electronic document corpus comprising a throughput of electronic documents;
for each individual document in the throughput of electronic documents:
generating a reduced-token abstractive summary data set for the individual document with a first language model;
conducting, using retrieval augmented generation, a semantic search to identify relevant criteria data from the criteria embedding vector database based on the reduced-token abstractive summary data set;
generating, with a second language model, retrieval-augmented text by performing semantic textual similarity with the identified criteria data and the reduced-token abstractive summary data set of the individual document; and
generating, with a third language model, a set of assessment outputs based on the reduced-token abstractive summary data set of the individual document and the retrieval-augmented text.

14. The non-transitory computer-readable medium or media of claim 13 wherein generating the reduced-token abstractive summary data set for each individual document in the throughput of electronic documents comprises:
dividing the individual document into token chunks;
separately generating a reduced-token data subset for each of the token chunks with the first language model; and
concatenating the reduced-token data subset for each of the token chunks to generate the reduced-token abstractive summary data set for the individual document.

15. The non-transitory computer-readable medium or media of claim 13, wherein generating the set of assessment outputs comprises:
generating, with the third language model, comparison text including natural language text indicating a comparison between the individual document and an inputted target topic based on the reduced-token abstractive summary data set and the retrieval-augmented text as criteria.

16. The non-transitory computer-readable medium or media of claim 13, wherein generating the set of assessment outputs comprises generating a confidence score indicating a degree to which the individual document includes text related to the inputted target topic.

17. The non-transitory computer-readable medium or media of claim 13, wherein the one or more sets of instructions configure the system for storing or outputting the sets of assessment outputs for each of the individual documents as an assessment corpus.

18. The non-transitory computer-readable medium or media of claim 13 includes data and/or instructions which configured the processing system to provide a multitier natural language processing architecture including a first tier and a second tier of natural language processing models; the second tier including at least one natural language processing model which is larger than the natural language processing models of the first tier.

19. The non-transitory computer-readable medium or media of claim 18 wherein the first tier includes the first language model; and the second tier includes the second language model.
